(19) United States
(12) Patent Application Publication
(10) Pub. No.: US 2018/0007922 A1
(43) Pub. Date: Jan. 11, 2018

(54) METHOD AND SYSTEM FOR MICROWAVE DECONTAMINATION OF FOOD SURFACES

(71) Applicant: Teknologisk Institut, Taastrup (DK)

(72) Inventors: Ann Mari Torngren, Taastrup (DK); Alexander Bardenshtein, Taastrup (DK); Jens Scheller Andersen, Taastrup (DK); Annemarie Gunvig, Taastrup (DK)

(21) Appl. No.: 15/545,540

(22) PCT Filed: Dec. 28, 2015
(86) PCT No.: PCT/EP2015/081282

§ 371 Date: Jul. 21, 2017

(30) Foreign Application Priority Data
Feb. 6, 2015 (DK) PA 2015 00063

(51) Int. Cl. A23B 4/01; A23L 3/01; A47J 27/10

(52) U.S. Cl. CPC A23B 4/012; A47J 27/10; A23L 3/01; A23L 13/70; A23L 5/13; A23V 2002/00

(57) ABSTRACT

A method and a system for decontamination the surface of food items such as meat pieces is described. A method includes obtaining at least one food item and/or at least one meat piece to be surface decontaminated, microwave treating the food item and/or the meat piece with microwaves in the range of 0.5-18 GHz such as 4-18 GHz, wherein the microwave treating is performed on at least one food item and/or meat piece which is packed in a packaging material, and/or the food item and/or meat piece pivot during microwave treating at least along two circular paths.

### CROSS-REFERENCE TO RELATED APPLICATIONS

The present application is a 373 national phase filing of International Application No. PCT/EP2015/081282, entitled “Method And System For Microwave Decontamination Of Food Surfaces”, filed 28 Dec. 2015, which claims priority to Denmark Patent Application No. PA 2015 00063, entitled “Method And System For Microwave Decontamination Of Food Surfaces”, filed 6 Feb. 2015.

### BACKGROUND

The present invention relates to a method and system for microwave decontamination of food surfaces, especially surfaces of meat pieces. Especially the invention relates to a method and system for microwave surface decontamination meat pieces having a non-processed interior before and after the microwave treatment.

Food such as meat products should be safe to the consumers and therefore the growth of pathogenic bacteria within or at such meat products should be limited or avoided. Reduction of the number of pathogenic bacteria can be performed at different steps from the time an animal is slaughtered and until just before the meat product is served to be eaten. Killing the bacteria as early as possible in the process where the number of bacteria is small is preferred to avoid multiplication of the bacteria and especially of bacteria that can be difficult to kill such as spores of Clostridium botulinum. In vacuum packed and chilled meat growth of C. botulinum must be avoided due to formation of a severe toxin.

When preserving meat pieces and meat products also the visual impression of the meat as well as the texture and taste of the meat should be considered. This makes it complicated to eliminate all pathogenic bacteria from meat pieces as e.g. a cooking process will amend the color, taste and texture of the meat.

Reliable preservation methods which reduce the number of spores and viable pathogenic bacteria and at the same time are gentle to the meat pieces would increase the quality of meat and products including meat. Reliable preservation methods will also increase the possibility of producing new food products or products treated differently which may increase the value such as the taste of the product.

U.S. Pat. No. 8,070,565 describes a method for loosening the feathers of a fowl prior to killing and processing, by exposing the fowl to a radio frequency source producing a frequency from between 5 GHz and 40 GHz for a predetermined period of time. The method may also be used for killing bacteria on the fowl prior to killing and processing. Decontamination of meat surfaces is however more efficient when performed after an animal has been slaughtered and cut into smaller pieces. Surface decontamination of meat pieces having a size which is suitable for storage may increase the products shelf-life considerably. Hereby surface decontamination of meat pieces may reduce the risk of infections such as human infections.

### SUMMARY

The invention relates to a method and a system for decontamination the surface of food items such as meat pieces. Surface decontamination of meat pieces may be performed at any time during the production process from an animal is slaughtered to the product is finalized by the last manufacturer and the food is ready to be delivered to the food service sector such as the to the grocery sector or delivered to consumers.

A method for surface decontaminating food items or meat pieces may comprise the steps of:
Obtaining at least one food item and/or at least one meat piece to be surface decontaminated,
Microwave treating the food item and/or the meat piece with microwaves in the range of 0.5-18 GHz such as 4-18 GHz, wherein the microwave treating is performed
   On at least one food item and/or meat piece which is packed in a packaging material, and/or
   the food item and/or meat piece pivot during microwave treating at least along two circular paths and hereby
Obtaining a surface decontaminated food item and/or meat piece.

Packaging the food/meat piece in a packaging material before microwave treatment may increase the effect of the microwave treatment by reducing the heating time and/or increasing the temperature at the surface of the food item or meat piece. A packaging material may be passive or active, where an active packaging material is a packaging material which interact with the microwaves and produce heat at the packaging surface. A packing material may be an active packaging material comprising a susceptor material capable of interacting with microwaves by becoming heated and hereby further reducing the heating time and/or increasing the temperature in the meat area to be decontaminated.

Vacuum sealing packaging material around a food/meat piece before microwave treating the food/meat piece may further increase the effect of the microwaves by increasing the contact between the packaging material optionally comprising a susceptor material.

Vacuum sealed food/meat pieces subjected to a decontamination process as described herein may further be subjected to a treatment step comprising:
Subjecting the surface decontaminated food/meat piece to a Sous Vide process, and/or
Marinating the food/meat piece before surface decontaminating the food/meat piece by microwaves.

Marinating the food/meat piece after surface decontamination of the food/meat piece by microwaves is possible for food decontaminated without being packed or after unpacking the decontaminated food/meat piece.

The invention also relates to a system for performing decontamination of at least one food item or meat piece, such system may comprise
A treatment chamber or first treatment chamber comprising
   at least one microwave emitting device capable of emitting microwaves in the range of 0.5-18 GHz such as 4-18 GHz into said treatment chamber, and
   means for rotating the at least one meat piece along at least two circular paths i.e. planetary movements, such as along two circular paths.

The system may also comprise microwave controlling means for controlling
Time of microwave treatment,
Power of emitted microwaves,
Microwave frequency, and/or
Cooling type and/or cooling time.

The system may further comprise
A second treatment chamber or a second treatment area of a horizontal or vertical treatment tunnel being similar or comprising many of the means of the first treatment chamber, and
Conveyor means for conveying meat pieces from the first treatment chamber to the second treatment chamber, for conveying meat pieces towards the first treatment chamber and/or away from the second treatment chamber.

The system may also comprise meat processing means such as at least one sous-vide bath, at least one marinating device and/or at least one mechanical tenderizer.

### BRIEF DESCRIPTION OF DRAWINGS

FIG. 1 shows the penetration depth of microwaves in red meat at frequencies between 2 and 7 GHz.

FIG. 2 shows a Cole-Cole diagram for water at 25° C.

FIGS. 3 to 6 show graphs of results from microwave experiments treating meat pieces surface contaminated with C. botulinum spores.

FIG. 7 shows a meat piece microwave treatment system with two treatment chambers.

FIGS. 8 to 11 show graphs of results from microwave experiments or water bath treating meat pieces surface contaminated with C. botulinum spores or C. botulinum vegetative cells.

FIG. 12 illustrates rotation in two circular paths.

FIG. 13 illustrates a system for decontaminating meat pieces.

FIG. 14 illustrates microwave heating of meat depending on meat size and penetration depth of the microwaves.

### DETAILED DESCRIPTION

An aspect of the invention relates to a method for decontamination the surface of food with a non-processed interior, where the method comprises the steps of:
Microwave treating a food item and/or meat piece with a non-processed interior with microwaves in the range of 0.5-18 GHz such as 4-18 GHz, wherein the microwave treating is performed
   On the at least one food item and/or meat piece which is packed in a packaging material, and/or
   Where said food item and/or meat piece during microwave treating pivot at least along two circular paths and hereby
Obtaining a surface decontaminated food item and/or meat piece.

Especially the method is a method for decontamination the surface of meat piece with a non-processed interior, where the method comprises the steps of:
a1. Microwave treating a meat piece with a non-processed interior with microwaves in the range of 0.5-18 GHz such as 4-18 GHz, wherein said microwave treating is performed on said at least one meat piece which is packed in a packaging material which is passive or active, such as with or without a susceptor material, or
a2. Microwave treating a meat piece with a non-processed interior with microwaves in the range of 0.5-4 GHz, such as 2.45 GHz, wherein said microwave treating is performed on said at least one meat piece which is packed in a packaging material which is active, such as with a susceptor material capable of interacting with microwaves by becoming heated,
b. Microwave treating the meat piece for a time period such that the meat surface becomes decontaminated and the interior of the meat piece is not heated substantially, and hereby
c. Obtaining a surface decontaminated meat piece with a non-processed interior.

The term ‘non-processed interior’ of a food item or meat piece should be understood such that the interior of the product has not been in contact with any processing tool such as a knife, needle, chopper etc. Examples of food items or meat pieces with a non-processed interior are entire fruit or vegetables, peeled fruit or vegetables, pieces of fruit or vegetables which have a size as described elsewhere herein, carcasses, and part of carcasses, meat pieces of a size as described elsewhere herein. The interior of a food item or meat piece can be determined as the inner part of the food item or meat piece having a distance of at least 1 cm from the outer part of the surface of the food item or meat piece, such as at least 8 mm from the outer surface, e.g. at least 5 mm from the outer surface. Preferably the food item or meat piece is not a minced product. Non-processed interior also means that the interior of a food item or meat piece has not been subjected to heat in an amount to amend the texture or color e.g. by coagulation of proteins. A non-processed interior may thus correspond to a raw interior such as raw meat. A non-processed interior of a meat piece may have been subjected to a cooling or freezing process before decontaminating the surface of the meat piece according to the method described herein and the interior of such meat pieces is still considered non-processed or raw after decontamination of the surface only.

Meat piece is to be understood as an entire piece of meat with an interior part which preferably has not been subjected to cutting, chopping or pricking means. Meat pieces may originate from a mammal or from a fish. A meat piece can have any size from 2 cm³ to an entire animal or an entire carcass or fish. Examples of meat pieces are fillet, ham, loin, tender loin, neck fillet, shoulder clod. Preferably the meat piece is a raw meat piece. The size in the form of thickness or diameter of a meat piece to be decontaminated with the method as described herein is preferably at least 2-3 times the wavelength of the used microwaves when the microwaves have a frequency of 4 GHz or more. The microwaves are preferably stopped by the surface of the meat hereby increasing the temperature of the meat surface. For microwave frequencies below 4 GHz the surface of the meat piece may be heated by the use of an active packaging such as a susceptor material e.g. as a part of a packaging material surrounding the meat.

Microwaves of 4-18 GHz have a penetration depth in beef of less than about 4.5 mm. Microwaves of these frequencies can thus be used for treatment of meat surfaces without heating the central part of a meat piece. Microwaves of 0.5-18 GHz such as 4-18 GHz can be used for decontamination food surfaces especially meat piece surfaces. Preferred is the C-band microwave with a frequency range from 5.8 GHz to 7.0 GHz and with wavelengths in air of between 7.5 cm and 3.75 cm. C-band microwaves have a very low penetration depth in meat. More preferred is the use of microwaves with frequencies of 5.8 to 6.1 GHz or 6.2 to 7.0 GHz. Most preferred are microwave frequencies of about 5.8 GHz. The frequency is meant to be the microwave frequency emitted from a microwave source. This microwave source may be capable of emitting microwaves with a single frequency or with more frequencies.

The microwave penetration depth (dₚ) is the depth in the material at which the microwave power has decreased to 1/e or simply to 36.8% of its original power outside this material. The measurements and calculations presented in Example 1 have shown the averaged penetration depth in raw beef at positive temperatures (from +10 to +60° C.) of dₚ=2.5 . . . 2.0 mm for the microwave frequencies f=5.8 . . . 7.0 GHz, correspondingly. Increasing the frequency above 7 GHz will decrease the penetration depth in meat.

The penetration depth of microwaves is also a key parameter defining the effect of “focusing” of the radiation in the food samples whose geometrical dimensions in all three directions are comparable, especially in the objects that are formed as spheres, cylinders or the like. The “focusing” effect, which can be also called the “spatial superposition” of microwaves is illustrated in FIG. 14. Indeed, if the doubled penetration depth of microwaves is less than the characteristic dimension of the food sample, then the focusing (superposition) does not occur (FIG. 14, left picture). On the contrary, if the doubled penetration depth is larger than the characteristic dimension of the food sample, the superposition of microwaves occurs inside the food as this is schematically shown in the right picture in FIG. 14. The result of this “focusing” or “superposition” is local overheating of the food in the core. Obviously, there must be an approximate critical characteristic dimension L_{cr} of a microwaved food sample that cause the superposition of microwaves of certain frequencies. Below these critical dimensions are estimated for 2.45 GHz and 5.8 GHz microwaves in the beef.

The power penetration depth dₚ is the depth at which the microwave power is attenuated by a factor of e=2.71828 . . . . Thus, the radiation loses approximately 63% of its power when it penetrates between the surface and this depth, but the residual 37% of microwave power is delivered deeper. This means that superposition of microwaves that takes place deeper than their power penetration depth may result in significant overheating of the core of a food sample. Therefore, it is assumed that the critical depth resulting in the superposition should be estimated from a penetration depth value that is larger than the power penetration depth. Actually, it is conventionally accepted that the penetration of microwaves at the depth of five power penetration depths results in practically full power attenuation so that only about 7% of the radiation power penetrates deeper.

Therefore, the critical characteristic dimension of a sample that enables microwave superposition can be defined as L_{cr}=10 dₚ. Since 2.45 GHz microwaves penetrate in beef down to dₚ=8.2 mm, the critical dimension is L_{cr}=8.2 cm. For 5.8 GHz microwaves that penetrate in beef down to dₚ=2.5 mm, the critical dimension of the meat piece is L_{cr}=2.5 cm. Conclusion: In order to avoid superposition (focusing) of microwaves and thus the overheat of the core of the processed meat, it is necessary to use the meat pieces whose geometrical dimensions are larger than approximately 8.2 cm for 2.45 GHz microwaves, and approximately 2.5 cm for 5.8 GHz microwaves.

The method as described herein enables fast microwave heating (thermal shock or heat stroke) in the very thin (up to 4-mm-thick) surface layer of the meat depending on the selected microwave frequency. Hereby the surface temperature may rapidly, e.g. within less than a minute from full microwave power is obtained, increase to e.g. about or above 90° C. which may be required for decontamination of meat surfaces. The heating rate will depend on the dimensions of the food/meat and the applied microwave power.

Thus, matching the dimensions of the meat pieces and the microwave power may enable such a high heating rate that the heat-affected zone of the meat will not extend further than the microwave penetration depth due to relatively low thermal conductivity of meat. Therefore, the texture of the core of the meat will remain unaffected while microorganisms, virus and/or spores that may be present at the surface of the food or meat may be reduced in number or fully eliminated due to heating and non-heating effects induced by the microwaves. Water present on a meat surface or close to the meat surface but inside the meat will also be heated and increase the effect in elimination of microorganisms, virus and/or spores on the meat surface. The water may start to boil and a vapor production can occur which may create good decontamination conditions at the surface layer of the meat piece. Vapor is up to 10 times more transparent to microwaves than water, thus the vapor production at the surface area of a meat piece makes it easier for the microwaves to enter into the meat surface and heat the surface. Thus, for meat pieces packed in a packaging material as described elsewhere herein the vapor production may increase the surface decontamination because at the boiling temperature such as at a temperature of about 100° C. and which can be maintained for the time period needed for decontamination condensation of vapor on the meat surface will occur. The method described herein may thus be a microwave treatment performed for a duration of time such that water boils and/or nearly boils at the meat surface and/or between the meat surface and a packaging material optionally also comprising a susceptor material and vapor is produced. The surface temperature can afterwards be maintained without or with only minor vapor production.

An embodiment of the method may relate to decontamination with microwaves where the power of the microwave treatment initially is high and when the water at the meat piece surface and/or the water between the meat piece surface and the packaging material boils or nearly boils the power of the microwave treatment is reduced to a level to maintain the water and/or produced steam at a pre-determined temperature such that substantially no more steam is produced inside the packaging material. If more steam is produced this may escape from the packaging as described elsewhere herein. The pre-determined temperature such as about 100° C. may be maintained for a pre-determined period to obtain a decontaminated meat surface.

After having reached the boiling point or steam production, the temperature at the surface of the food item or meat piece may be maintained at a pre-determined temperature by lowering the power of the microwave heating the product and/or by pulsing the microwave in an on-off pattern with pulses of microwaves. As the thermal conductivity of different food products may vary due to the content of e.g. water, fat and protein (meat), the exact duration of microwave treatment with a specific frequency and power should be determined for different products such as for different meat pieces.

For microwaves with frequencies below about 4 GHz, such as 0.5-4 GHz the penetration depth is rather high for meat and the meat may thus be surrounded by a susceptor material capable to catch or interact with the main part of the microwaves such that the susceptor material itself becomes heated and can transfer this heat to the meat surface and/or water at or just inside the meat surface. Also the meat surface may be heated by the microwaves with frequencies below about 4 GHz, such as 0.5-4 GHz, as the packaging material that may include susceptor material preferably allows some of the microwaves to penetrate into the meat. Heating meat pieces with microwaves with frequencies below about 4 GHz without using a susceptor material at the surface of the meat may result in heating too much of the interior of the meat as the microwaves penetrates further into the meat and too deep than requested for a surface decontamination leaving the interior of the meat non-processed.

The method as described herein may be used for surface treating of food in general. Preferably, the method is for surface treating meat products such as products comprising cut meat pieces and/or meat slices. Most preferably the method is for surface decontamination of meat cuts. The method is more preferably used for surface treating at least one solid unit comprising meat pieces and/or for surface treating at least one entire meat piece. The method is most preferably used for surface treating at least one entire meat piece of a size of at least 5 cm³. Any meat piece of at least 5 cm³ may be surface decontaminated by the method described herein. In addition, carcasses, half-carcasses and carcass parts such as fore part, hind part and parts obtained by three, four or five piece cutting of half-carcasses may be treated according to the method described herein. Also surface decontamination of fish or fish pieces are preferred.

Microwaves are a part of electromagnetic spectrum with frequencies between 300 MHz (0.3 GHz) and 300 GHz, and have too low energy of quantum (˜10⁻⁶-10⁻³ eV) to cause any irreversible change in any biological tissue by means of its ionization, as e.g. X-rays or even UV electromagnetic radiation can do. For comparison, the threshold region of quantum energy for ionization is ˜5-20 eV.

Furthermore, the microwave wavelengths are between 0.1 mm and 1 m, and the characteristic dimensions of pathogenic microorganisms are in the range of micrometres. For example, C. botulinum organisms are 1.6-22.0 μm in length and 0.5-2.0 μm in width. These dimensions of bacteria do not allow their direct interaction with microwaves. The microorganisms are too small to be “noticed” by microwaves in order to transfer them electromagnetic energy. Thus, if microorganisms are subjected to microwave irradiation while being suspended in free space, e.g. in clean atmospheric air, which does not contain any objects capable of direct absorption of electromagnetic energy of microwaves, then nothing happens to these microorganisms.

The situation changes dramatically for the microorganisms if they have a thermal contact to any object or substance that is capable of efficient absorption of electromagnetic energy of microwaves. In the art in scope, such a substance can be water, and the objects are particularly tissues with high water content, or more particularly meat, or more specifically, muscular tissues. The water molecules are polar, that is, they are electric dipoles, which experience regular motion in an alternating electromagnetic field of a microwave. The kinetic energy of this motion transforms into heat and the tissue thereby gets hot. Since microorganisms have a thermal contact to the tissue as they are present in the water phase of the meat, their temperature increases too. If a specific temperature and the time of application of this temperature appear within certain threshold regions, which are individual for each kind of microorganisms, they die or lose their eugenesis.

The method as described herein may be based on thermal shock applied at the food/meat surface and thermal shock is considered in relation to microorganism. Thermal shock is the process of application of temperature that is within or above the threshold region, for relatively short time, for example for less than 1 minute. By other words, thermal shock is a process of high-rate heating. Apparently, the higher the temperature is the shorter the time of its application to microorganisms is needed in order to kill or to abort their reproduction capacity. Thus, thermal shock is a faster way of killing microorganisms or abortion of their reproduction than a delayed heating process. Since C-band microwaves penetrate into tissue and then instantaneously and effectively deposit their energy within a relatively short penetration depth of 2-3 mm, the C-band microwaves are a convenient mean of a microwave-induced thermal shock. The X-band and Kᵤ-band microwaves have a shorter penetration depth than the C-band microwaves and may also be suitable for decontamination of meat surfaces.

By decontamination is meant a process of killing or abortion of reproduction of pathogenic microorganisms, i.e. microbiological contaminants. When decontaminating a food or meat surface the surface need not be sterilised where all microorganisms or spores are killed or inactivated. By decontamination, the level of microorganisms or spores at the meat surface are brought below a level (i.e. below a number of microorganism or spores), which ensures a low risk for infection of human.

Meat and/or food surfaces, where decontamination should be performed according to the method described herein, can be defined as a liquid-phase interface between the food or meat becoming decontaminated and the surroundings, e.g. air, or packaging material etc. where reproduction of microorganisms is hindered due to the decontamination process. This also means that this interface layer can be relatively thick, that is, not necessarily microscopic.

A meat surface layer indicating the decontamination process by a colour change may have an average thickness of between 1-10 mm, such as between 1.5-9 mm, e.g. as between 2-8 mm, such as between 2.5-7 mm, e.g. as between 3-6 mm, such as between 3.5-5 mm, e.g. as between 2-5 mm. Preferably the meat surface layer indicating the decontamination process by a colour change has an average thickness of less than 7 mm, such as less than 6 mm, e.g. less than 5 mm, such as less than 4 mm, e.g. less than 3.5 mm, such as less than 3 mm, e.g. less than 2.5 mm.

When microwave treating the food piece and/or meat piece with microwaves in the range of 0.5-18 GHz such as 4-18 GHz, the microwave treating can be further performed with one or more characteristics:
a. With simultaneously cooling of the at least one food item and/or meat piece, and/or
b. The food piece and/or meat piece may be packed in a packaging material, and/or
c. Where the packing is with a susceptor material, and/or
d. On at least one food and/or meat piece which is vacuum packed, and/or
e. At a relative humidity of at least 40% at the surface of the at least one food and/or meat piece, and/or
f. On at least one meat piece of at least 25 cm³, and/or
g. Such that the surface temperature of the food and/or meat is at least 70° C. and the temperature of the food and/or meat in a depth of 5 mm is below 70° C. when the microwave treating is stopped, and/or
h. On at least one food item and/or meat piece at least surface treated with marinade, such as a salt-containing marinade.

Packing the food/meat piece before microwave treating can have at least two effects. The covered food/meat piece will not be subjected to further contamination with microorganisms if the packing material encloses the food/meat piece or prevent contact with contaminate items or contaminated surroundings e.g. air. The covering of the food/meat may also give rise to changed conditions at the surface of the food/meat when compared to non-covered food/meat. The covering may cause a rise of temperature and/or humidity at the surface of the food/meat piece when performing the microwave treatment.

Pivoting the food/meat piece may result in a more even distribution of the microwaves at the surface of the food/meat, however, turning the food/meat piece at a rotating table in the bottom of a microwave oven may not result in an even treatment of the food/meat piece. Pivoting the food/meat piece e.g. horizontally and vertically at the same time or in two orbit path horizontally or vertically increases the possibility of an even treatment of the surface of the food/meat piece.

Subjecting the food/meat piece to cooling during the microwave treatment may secure a short time of heating the surface of the food/meat piece and subsequent cooling the surface without directing the heat from the surface of the food/meat piece towards the inner part of the food/meat piece and hereby obtain a food/meat piece with a decontaminated surface and a raw or non-treated inner part.

The packaging material may have a thickness of at least 5 μm. However, the function of the material is not a matter of solely the thickness. The packaging material may also provide oxygen and water vapour barriers securing a desired shelf life of a food/meat product. Preferably, the packaging material or packaging film should not lose its mechanical and chemical stability up to the temperatures of at least above 100° C., such as 105° C. Furthermore, the packaging material should preferably have a low oxygen and water vapour permeation, as these are necessary to secure desirable shelf life of a decontaminated food/meat product.

The packaging material may be any film or paper suitable to be subjected to microwaves when being in contact with food or meat. Films or papers for microwave packaging of foods with different properties are known in the art. The film or paper used for food/meat packaging according to the present invention should preferably be suitable to function when in contact with meat and/or fat and being capable of withstanding high temperatures of at least 100° C. without being interrupted and without loosening its mechanical strength and barrier properties.

The packaging material may comprise steam or overpressure valves capable of directing steam from inside the material to the outside of the material. The overpressure valves prevent inflation of packaging film by overheated moist air during decontamination. These valves are closed until the pressure inside the packaging reaches a certain value. When this happens, the valve opens and the pressure thereby reduces either down to the critical (opening) value, if the valves are reversible, or down to the ambient pressure, if the valves are irreversible.

Material with reversible or irreversible valves can be selected due to the determined decontamination method where reversible valves may be included in maintaining the temperature above a certain level for a desired time by keeping the pressure at a certain level above ambient pressure. Irreversible valves can be selected to improve the cooling effect after overpressure is reached and the valves let out steam until ambient pressure is reached again. The packaging material may also be of a semi-permeable membrane or material having the same function as described for the material comprising valves i.e. allowing steam to diffuse out of the packaging material.

The packaging material may further comprise a susceptible material capable of interacting with microwaves and hereby become hot. Such susceptible material is called a susceptor material or susceptor.

Preferably the at least one food and/or meat piece is packed into a packaging material with susceptors while being subjected to microwave treatment.

Packaging material with susceptors, which is used to package food or meat pieces, can be composed of a plastic film or paper and a thin layer or a pattern deposited onto the film/paper, which layer or pattern comprises electrically conductive particles. The electrically conductive particles may be carbon, aluminum or stainless steel or another metal. Susceptors help increasing the temperature close to the electrically conductive particles as the microwave interacting material i.e. the electrically conductive particles convert the energy in the microwaves into heat. The temperature at the surface of a susceptor may when being subjected to microwaves increase within a very short time e.g. within seconds to above 100° C.

Packaging material with susceptors can be designed to reach and remain at a predetermined temperature and heat energy output as described in e.g. U.S. Pat. No. 4,962,293.

Decontaminating the surface of a meat piece with the use of packaging material with susceptors and microwaves may thus be due to different heating processes. The susceptor may reflect, absorb or transmit microwave energy. The transmitted energy may heat up the water molecules in the outermost surface of the food or meat piece and the microwave energy absorbed by the susceptor can be converted to heat at the surface of the meat piece when the susceptor and the meat piece is in contact with each other. Hereby only a thin surface layer of the meat piece need to be heated which can be performed very quickly and without heating the inner part of the meat piece.

The susceptible material may increase the surface temperature of the food/meat piece to at least 100° C. within 30 seconds from the time the microwaves are at full power.

The susceptors are preferably produced from a flexible material that adapts itself to emit heat when it absorbs microwaves and increases the meat surface temperature to at least 90° C., such as about 100° C. within 30 seconds from the time the microwave radiation is applied.

The rate of the temperature rise depends on the mass of the susceptor material and the heat transfer to the food/meat piece and surrounding air. The longest heating time to achieve the working temperature is preferably no longer than 1-5 seconds. Working temperature of the susceptor can be adjusted as described e.g. in the U.S. Pat. No. 5,038,009.

The packaging material may be sealed such that the food/meat piece is fully enclosed in the packaging material. Preferably the sealed packaging material is airtight for ingoing air both before and after being subjected to microwaves. Ingoing air including oxygen can start a process such that the food/meat can get rancid and/or get a taste of being reheated (warmed overflavoured). Ingoing air may also comprise microorganisms which may re-contaminate the surface of the food/meat.

Air may be aspirated from the volume between the food/meat and the packaging material before or during sealing the packaging material. The material may be sealed by vacuum sealing. Aspirating air from the package comprising a food/meat piece to be decontaminated by the method described herein secure a close contact between the packaging material and the food/meat piece which is preferred especially when a packaging material with susceptors is used. The close contact may secure fast heating of the food/meat surface when the packaging is subjected to microwaves.

In addition, air between the meat piece and the packaging material can be replaced with a controlled surrounding. Such a controlled surrounding may be a gas selected from the group of nitrogen, oxygen and/or carbon dioxide. The controlled surrounding may be selected from a gas mix of nitrogen and oxygen, nitrogen and carbon dioxide, oxygen and carbon dioxide, or nitrogen, oxygen and carbon dioxide. The content of each gas may be as used e.g. when packing meat e.g. minced meat in a gas filled packing

The microwave emitting device may have a power between 500 and 10,000 W. Preferably the power is between 600 and 5,000 W, such as between 700 and 3,000 W, e.g. between 800 and 2,500 W.

The microwave treatment process as described herein may be performed for a period of e.g. 5 to 600 seconds. Preferably the microwave treatment calculated from the time full microwave power is obtained, is performed for less than 5 minutes, such as less than 4 minutes, more preferably less than 3 minutes, e.g. less than 2.5 minutes, such as less than 2 minutes, e.g. less than 1.5 minutes, e.g. less than 1 minute, such as less than 30 seconds. The process may also be stepwise as described elsewhere with a first treatment at high power for less than 2 minutes, e.g. less than 1.5 minutes, such as less than 1 minute, e.g. less than 30 sec, and a second treatment at lower power of microwaves and/or pulses of microwaves for a longer period of e.g. 1-6 minutes, such as 1-5 minutes, e.g. 2-5 minutes, such as 2-4 minutes, e.g. 2-3 minutes, such as 3-4 minutes.

The microwave treatment time may be determined due to the treatment conditions such as microwave frequency, microwave power, size of food/meat piece, presence or absence of a susceptor material in the packaging material as well as purpose of the decontamination treatment, e.g. what kind of microorganisms can be present and how deep should the heat-affected zone in the food/meat piece be.

In a preferred embodiment the surface of meat pieces of e.g. 0.2 kg to 4 kg can be decontaminated at 5.8 MHz microwaves by treating the meat piece for 0.25 to 5 minutes at a power of 1,000 to 5,000 W. Such a treatment may be with a first and a second treatment with high and low/pulse power, respectively.

An estimate of the treatment time can be performed as indicated in the following estimation: The estimations are carried out for a processing throughput of 300 kg/hour and with 2-kg, 10-cm-diam cylindrical pieces of non-treated roast beef for surface decontamination. Since the mass density of unprocessed lean beef ρ=1.15 g/cm³, the length of each piece of meat is approximately 22 cm, and the processing surface area is thus S=853 cm². Combining the process throughput and the mass of the processed meat piece, the shortest duration of the superficial microwave-heating stroke is τ=24 s. It can be shown that the heat-converted microwave energy required for superficial heating Q=ρSCₚdₚΔT, where Cₚ=3,700 3/(kg·K) is the specific heat capacity of meat, and the penetration depths dₚ for 5.8 GHz and 7.0 GHz microwave radiation are 2.50 mm and 1.98 mm, correspondingly. Thus, the required microwave power P=Q/τ=3.213 kW for 5.8 GHz and 2.544 kW for 7.0 GHz.

With a penetration depths dₚ of 2.5 mm, the mass density of the lean beef ρ=1.15 g/cm³ (1150 kg/m³), the specific heat capacity of meat Cₚ=3,700 3/(kg·K) and the thermal conductivity κ=0.45 W/(mK) then the thermal diffusivity becomes α=υ/ρCₚ=1.058×10⁻⁷ m²/s, which is a typical value for unfrozen foods (Buffler, C. R. Microwave Cooking and Processing. Engineering Fundamentals for the Food Scientist, New York, AVI Book (1993)). Thermal relaxation in lean beef subjected to 5.8 GHz microwave treatment can be calculated as τ=Cₚρdₚ²/κ=dₚ²/α=59.097 sek≈1 minute.

In an embodiment meat surfaces are decontaminated by applying energy to the surface of the meat pieces in an amount of 100-400 J/cm², such as 175-375 J/cm², e.g. 200-350 J/cm², such as 175-325 J/cm², e.g. 200-300 J/cm², such as 225-275 J/cm², e.g. 240-260 J/cm², such as about 250 J/cm². The energy may be applied as a first high-power microwave treatment and a second low-power and/or pulsed microwave treatment.

The food/meat piece may be cooled simultaneously with the microwave treatment such that combination of microwaving and cooling provide for the necessary temperature at the surface of the food/meat for the time necessary for decontamination. Cooling may be performed for at least 40% of the time of the microwave treatment. Preferably the cooling is performed in the last part of the microwave treatment such as in the low power and/or pulsed microwave treatment. The cooling process may continue after the microwaves treatment is ended, hereby a fast cooling of the surface of the food/meat piece may be obtained.

The cooling may be performed by air or water passing by the food/meat piece. Air or water used for cooling may be substantially without any infectious microorgansims. Preferably the food/meat piece is packaged into a package material when cooled by water.

The air or water used for cooling may have a temperature below 70° C. Preferably the cooling temperature of air and water is between 0 and 50° C., such as between 10 and 40° C., e.g. between 20° C. and 30° C. Most preferably air or water is used at a temperature where it should not be heated or cooled before used for the cooling process.

The at least one food item or meat piece treated by the method described herein is preferably a non-cooked food item or meat piece. Non-cooked meat means raw meat, cooled raw meat, frozen raw meat, and thawed raw meat. Non-cooked meat may at the surface be spiced with spices or flavored with herbs and/or marinated. Cooled raw meat may have at temperature below 25° C. before being surface decontaminated as described herein, such as below 20° C., e.g. below 15° C., such as below 10° C., e.g. below 7° C., such as below 5° C., e.g. below 3° C., such as below 1° C., e.g. below 0° C. Preferably cooled raw meat has a temperature below 10° C. before being surface decontaminated, such as between 0-9° C., e.g. 1-8° C., such as 1-7° C., e.g. 1-6° C., such as 1-5° C., e.g. 1-4° C., such as 1-3° C.

The at least one meat piece and/or food piece has a size of at least 1 cm*1 cm*2 cm when being subjected to the decontamination process described herein. Preferably the meat piece has a size of at least 5 cm in one dimension. More preferably the meat piece has a size of at least 5 cm in two dimensions. Most preferably the meat piece has a size of at least 5 cm in three dimensions. The used microwave effect in a system for surface decontamination may determine the smallest meat dimensions as this is based on the penetration depth of the microwaves as described elsewhere.

The at least one meat piece to be decontaminated may have a size with a volume of at least 2 cm³. Preferably the meat piece has a size of at least 5 cm³, such as at least 10 cm³, e.g. at least 20 cm³, such as at least 30 cm³, e.g. at least 40 cm³. More preferably the meat piece has a size of at least 50 cm³, such as at least 60 cm³, e.g. at least 70 cm³, such as at least 80 cm³, e.g. at least 100 cm³. Further preferably the meat piece has a size of at least 150 cm³, such as at least 200 cm³, e.g. at least 250 cm³, such as at least 300 cm³, e.g. at least 350 cm³, such as at least 400 cm³, e.g. at least 450 cm³. Most preferably the meat piece has a size of at least 500 cm³, such as at least 550 cm³, e.g. at least 600 cm³, such as at least 650 cm³, e.g. at least 700 cm³, such as at least 750 cm³, e.g. at least 800 cm³, such as at least 850 cm³, e.g. at least 900 cm³, such as at least 950 cm³, e.g. at least 1000 cm³.

Most preferably the meat piece sizes are the sizes of meat when delivered from an abattoir or the meat piece sizes being ready to be offered for sale to a consumer. Meat pieces delivered from an abattoir may be subjected to further cutting before being offered to sale to a consumer. A consumer may be e.g. an eatery or an individual person.

The at least one food piece or meat piece may have a weight of at least 5 g, such as at least 10 g, e.g. at least 50 g, such as at least 100 g, e.g. at least 500 g, such as at least 1,000 g, e.g. at least 1,500 g, such as at least 2,000 g, e.g. at least 3,000 g, such as at least 4,000 g, e.g. at least 5,000 g, such as at least 10,000 g.

The at least one food or meat piece may after microwave treatment have a surface layer which shows a color change. The color change is preferably caused by the heating process. In raw red meat the color change induced by the heating may be from red to grey or brown. The surface layer showing a color change due to the decontamination process as described herein is preferably less than 10 mm, such as less than 8 mm, e.g. less than 6 mm, such as less than 4 mm, e.g. about 3 mm, such as about 2 mm. The thickness of the surface layer showing the color change may vary within a single food or meat piece, due to variation in the meat surface e.g. composition of meat and fat, presence of cuttings and depth of these as well as variation of microwave power in the process chamber.

The method as described herein for decontamination reduces the number of viable microorganisms. Such microorganisms may be Escherichia coli, Salmonella ssp, Shigella dysenteriae, Clostridium botulinum, Listeria monocytogenes.

The reduction of viable microorganisms is at least 1 log, such as at least 2 log, e.g. at least 3 log, such as at least 4 log, e.g. at least 5 log, such as at least 6 log. Preferably the reduction of viable microorganisms and/or their spores are at least 4 log. More preferably the reduction is at least 5 log. Most preferably the reduction is at least 6 log. Each 1 log reduction corresponds to a 90% reduction of the microorganism in focus.

Thus a treatment giving a 1 log reduction (90%) of e.g. C. botulinum may result in e.g. a 3 log (99.9%) reduction of another microorganism species.

To obtain a shelf life of more than 10 days it is today recommended that the meat surface must be heat treated to at least 90° C. for 10 minutes. The surface decontamination may be performed for a time and temperature combination sufficient to inactivate C. botulinum spores in a corresponding amount. To ensure longer shelf life of meat a reduction of 6 log of spores of C. botulinum is preferably obtained. A treatment that obtains a 6 log reduction will also ensure that all vegetative bacteria are inactivated or at least are inactivated to a non-infectious level.

The at least one meat piece to be treated with the decontamination method as described herein may be from an animal selected from the group of any animal eaten by human such as pig, cow, cattle, sheep, goat, deer, horse, poultry, fish. Fish may be selected from the group of salmon, codfish, tuna, whale, shark.

In an embodiment the method further comprises a treatment step, the treatment step comprises:
Subjecting the at least one surface decontaminated food/meat piece to a Sous Vide process, and/or
Marinating the at least one surface decontaminated food/meat piece.

The decontaminated food/meat piece may be sous vide processed by heat treatment of vacuum packed food/meat in water containers or in ovens at temperature between 53° C.-100° C. i.e. below 100° C. for up to 72 hours. The food/meat piece may be vacuum packed before decontaminating the food/meat piece as described herein, however, the food/meat piece may also be vacuum packed after the decontaminating process and before being sous vide processed. A food/meat piece decontaminated as described herein may be marinated, vacuum packed and subjected to a sous vide process, preferably the meat piece is marinated and vacuum packed before being surface decontaminated, and then sous vide processed.

Marinating may comprise treating the food/meat piece with salt such as a brine. The brine treatment may be performed by immersing the at least one meat piece in a brine solution or it may be introduced into the meat by injection. Marinating may also be performed with at liquid comprising spices. Preferably marinating by injection is performed after meat pieces have been subjected to surface decontamination by microwave treatment. Most preferably marinating of a meat piece is performed before the microwave treatment such as before a packaging process. Marinating meat pieces decreases the penetration depth of the microwaves 5-10 times and hereby the thickness of the meat piece surface showing the result of the decontamination process is also decreased. The effect of the marinade to decreasing the penetration depth of the microwaves may depend on the concentration of electrolytes present on the meat surface during the microwave treatment, and may depend on the amount of salts, vinegar and sucker.

Another aspect of the invention relates to a system for decontaminating at least one food item and/or at least one meat piece, the system comprises
A treatment chamber comprising
   at least one microwave emitting device capable of emitting microwaves in the range of 0.5-18 GHz such as 4-18 GHz into the treatment chamber, and
   means for planetary movement of at least one food item or meat piece.

In an embodiment the system comprises at least one treatment chamber which is a treatment chamber for a continuous process such as a tunnel e.g. a horizontal or vertical tunnel or it comprises at least two treatment chambers located next to each other such as beside each other or one above the other, and the system may comprise
a. at least two microwave emitting devices capable of emitting microwaves in at least part of the range of 0.5-18 GHz,
b. the at least two microwave emitting devices are located within the system such that at least one microwave emitting devices is located in a first section located close to an entrance of the system where a high power treatment is to be performed and at least one microwave emitting devices is located in a second section of the system where a lower power treatment and/or a pulsed treatment is to be performed,
c. means for adjusting the power of the microwave emitting device such that the power in the second section is 10-90% lower than in the first section and/or is pulsed,
d. a conveyor system for transporting meat pieces through the treatment chamber(s) and where the system comprises means for rotating the at least one meat piece along at least two circular paths.

The system may further comprise
at least one temperature sensor for determining the temperature within the treatment chamber and/or for determining surface temperature of at least one food/meat piece in the treatment chamber, and/or for determining the surface temperature of a packaging enclosing at least one food/meat piece in the treatment chamber and/or
at least one cooling device for cooling the atmosphere of the treatment chamber and/or for cooling the at least one food/meat piece in the treatment chamber.

Consumer microwave ovens usually use 2.45 gigahertz (GHz) with a wavelength of 12.2 cm while large industrial/commercial microwave ovens often use 915 megahertz (MHz) with a wavelength of 32.8 cm. These frequencies or rather their corresponding wavelengths—although given for transmission in air—are far too long for surface decontamination of food/meat pieces where only a small outer layer of the food/meat should be heated and the central part of the food/meat piece should preferably not be heated. Active packaging may be used for surface decontamination of food at frequencies below 4 GHz.

The microwave emitting device may be capable of emitting microwaves in the range of 0.5-18 GHz such as 4-18 GHz. Preferred is a frequency of 5.8 GHz (5.6-6.0 GHz can be the spectrum from e.g. a magnetron). Also preferred is a frequency of between 10 and 18 GHz.

For decontamination of food/meat pieces by microwaves, a frequency up to approximately 18 GHz, and at the same time, as high microwave power as possible may be preferable. With regard to the power, the reason is simple: the higher the power, the higher the heating rate and, therefore, the shorter the decontamination time might become. Regarding the frequency, it should be so that two conditions are matched: the penetration depth must be as short as possible, and the microwave power absorption should at the same time be as effective as possible. These two conditions are not always met as further described herein.

The system may comprise at least one microwave emitting device capable of emitting microwaves in at least part of the range of 0.5-18 GHz such as at least two microwave emitting devices each capable of emitting microwaves in the entire ranges or part of the ranges selected amount 0.5-4 GHz, 4-8 GHz, 8-12 GHz or 12-18 GHz. Preferably the system comprises in one chamber such as in a first treatment chamber and/or in a second treatment chamber at least two microwave emitting devices each capable of emitting microwaves in the entire range or part of a range selected between:
4-8 GHz (C band),
8-12 GHz (X band) or
12-18 GHz (Kᵤ band).

The system may also comprise power controlling means for controlling the power of the microwaves.

Preferably the power of the system should be at least 700 W, such as at least 800 W, e.g. at least 900 W, such as at least 1000 W. Example of a suitable power is 2.5 kW for 7 GHz, 3.2 kW for 5.8 GHz. The power is the energy used to produce the microwaves. An entire microwave system may thus use more energy than indicated above as part of the energy used by a microwave emitting device is dissipated as heat.

The physical constants of food materials that are used to characterise their interaction with microwaves, including the microwave energy dissipation, are called a dielectric permittivity (a dielectric constant, a common symbol is ∈′) and a dielectric loss factor (a common symbol is EP). In the C-band microwave frequency range, ∈′=50 . . . 70, and ∈″=20 . . . 30 for water and high water content materials.

The Cole-Cole equation curve, which is shown in FIG. 2 shows the relation between dielectric permittivity ∈′ and the dielectric loss factor ∈″ for water and at different frequencies of microwave radiation (high frequency at the left, low frequency at the right as indicated by the three frequencies on the graph). It can be seen from the diagram that the dielectric loss factor peaks at 18 GHz and decreases both at higher and lower frequencies; on the contrary, the dielectric constant is maximized at lower frequencies and gradually decreases as the microwave frequency increases above 18 GHz.

The absorbed microwave power is directly proportional to the dielectric loss factor ∈″, and the microwave penetration depth is directly proportional to the ratio \sqrt{∈′}/∈″. This means that the penetration depth of microwaves decreases as the frequency increases; and the absorbed microwave power reaches its maximum at 18 GHz and then decreases as the frequency increases. The decrease of the penetration depth is a positive factor with regard to the task of the surface decontamination. However, the decrease of the absorbed microwave power at the frequencies above 18 GHz makes the heating and therefore the decontamination process less effective.

Microwaves of 4-18 GHz thus have a wavelength short enough to secure only heating of a surface layer of food/meat pieces, and combined with the energy in the waves, the dielectric constant as well as the dielectric loss factor, these microwaves are considered suitable for decontaminating surfaces of food/meat pieces without heating the inner part of the food/meat pieces.

Since typical output frequencies range for gyrotrons are from about 20 GHz to 250 GHz, gyrotron-radiated microwaves are, in accordance with the above conclusion, less suitable for surface decontamination than the lower frequency microwave radiation. Preferably the decontamination of food or meat surfaces are not performed with the use of a gyrotron.

The system may further comprise treatment controlling means for controlling the treatment conditions when treating at least one food/meat piece. Such treatment conditions may be microwave frequency, power, microwave emitting time i.e. treatment time, and/or cooling. Treatment conditions may be determined due to the size such as weight or volume of food/meat pieces to be surface treated and/or the packaging conditions. The treatment conditions may be entered manually at an input means being part of the treatment controlling means or being in connection with the treatment controlling means. A weight or a meat size determining means may be used to determine the weight or volume of a food/meat piece, and this weight or meat size determining means may be connected to the treatment controlling means for automatic transfer of the size e.g. as weight or volume to the treatment controlling means. The treatment controlling means may determine the treatment time based on the type, weight and/or volume of the food/meat piece.

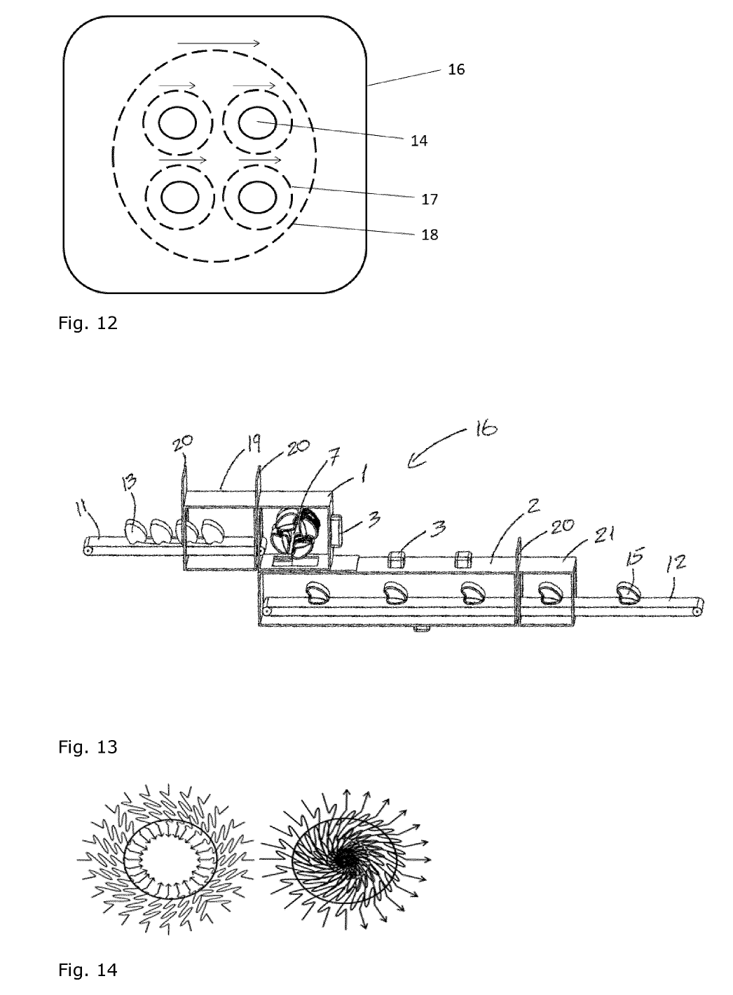

A treatment controlling means may be a time controlling means for controlling the microwave emitting time. A treatment time determined by a time controlling means may be determined due to the size such as weight or volume of food/meat pieces to be surface treated. The treatment time may be entered manually at input means being part of the time controlling means or being in connection with the time controlling means. A weight or a meat size determining means may be used to determine the weight or volume of a food/meat piece, and this weight or meat size determining means may be connected to the time controlling means for automatic transfer of the size e.g. as weight or volume to the time controlling means. The time controlling means may determine the treatment time based on the weight and/or volume of the food/meat piece. The system may further comprise a rotating means for rotating the at least one meat piece. The rotating means may rotate in one first orbit or circular path. Preferably the rotating means can rotate the at least one meat piece simultaneously along a second orbit or circular path hereby obtaining a planetary movement. The first orbit or circular path may be identical for a number of food/meat pieces located in a rotating means, whereas the second orbit or circular path may be different for each food/meat piece. By rotating the food/meat pieces along two orbits or circular paths e.g. in a planetary movement at the same time the individual food/meat pieces may be more homogenous treated by microwaves. Rotating meat pieces in two circular paths is illustrated in FIG. 12.

In another preferred embodiment at least two microwave emitting devices are present in the treatment chamber reducing the requirement for rotating means in the treatment chamber. With two or more microwave emitting devices in the treatment chamber the rotating means performing planetary movements need not be present. However the rotating means performing planetary movements is preferred as usually microwave distribution in a treatment chamber is not uniform.

The system may for performing circular paths or planetary movement of meat pieces comprise a supporting device with at least one basket for holding at least one meat piece during treatment of the at least one food/meat piece. The supporting device with at least one basket may during the treatment with microwaves rotate along a first orbit or circular path and optionally said at least one basket may at the same time rotate along a second orbit or circular path by rotating around itself. Preferable is when the supporting device and the at least one basket rotate along a first and a second orbit or circular path during microwave treatment.

The cooling device may comprise an air-flow cooling device and/or a water cooling device. An air-flow or water cooling device may be combined with an ultrasound generating device.

Ultrasound can improve or assist heat transfer processes from the air flowing around a cooling food/meat piece. The heat transfer happens because near the surface of the food/meat piece streamlined by any viscous fluid, there is always a so-called laminar boundary layer where the flow speed vanishes due to viscous friction. This still laminar boundary layer of air (fluid) thereby becomes a very good thermal insulator that does not allow any or only limited heat exchange between the food/meat piece and the air flow, that is the cooling process itself. There are two possibilities to eliminate, or at least to extensively thin this laminar boundary layer: First method is to increase the flow speed so that the heat transfer would become satisfactory. This method is called “forced convection”. However, this will not enable independent control of cooling and energy consumption. Another method is to apply high-power ultrasound at the surface of the cooled food/meat piece. Air molecules will vibrate in the acoustic field and thereby will enable the heat transfer process. This method is more flexible since it enables control of the cooling not only by means of flow speed, but also by means of ultrasound frequency and intensity.

Ultrasound can also improve heat exchange in the water flow when using water for cooling a food/meat piece. However, the ultrasound needs to be generated in the water in order to be applied at the surface of the food/meat piece streamlined by water. This is because the acoustic waves generated in the air practically do not penetrate in the water, and vice versa, the acoustic waves generated in the water practically do not penetrate in the air. This happens because of a huge difference in acoustic impedances of air and water. There are though some exceptions when the so-called leaky waves can penetrate through the air-water interface. However, the leaky waves do not carry enough energy to enable the improved heat transfer.

The decision of using ultrasound rather than increasing the flow speed for improving the heat transfer can be taken on the basis of comparison of the energy needed for ultrasound generation and the energy spent for increasing the flow speed in order to achieve the same value of heat-transfer coefficient in the flow.

The treatment chamber of the system may have a size suitable for treating at least one food/meat piece corresponding. Preferably the treatment chamber has a size of at least 12 liter.

The system may also comprise at least one outlet for steam. Steam may be produced by the food/meat piece during treatment and heating. An outlet for steam may be a part of a cooling device.

The system may comprise microwave controlling means for controlling time of microwave treatment and/or power of emitted microwaves. A microwave controlling means may be part of a treatment controlling means as described above.

The system preferably comprise a computer or processor for receiving input before and during microwave treatment and based on these input determine a possible output capable of changing at least one setting of the system, the input may be any information important to determine the treatment conditions and such information can be selected from the group of:
Size and/or weight of at least one food/meat piece to be treated;
Total weight of at least two meat pieces to be treated simultaneously;
Type of at least one food/meat piece to be treated;
Type of packaging or no packaging;
Temperature of the atmosphere within the chamber during microwave treatment;
Temperature of the surface of the food/meat pieces during microwave treatment;
Amount of steam within the treatment chamber;
And where possible at least one output can be an output selected from the group of or sent to the:
Means for controlling the frequency of the emitted microwaves;
Power controlling means for adjusting the power of the microwave emitting device such as pulsing the microwaves;
Cooling device for adjusting the degree of cooling within the treatment chamber;
Time controlling means for adjusting the time for emitting microwaves;
Rotating means for adjusting the rotating direction and/or adjusting the rotation speed.

The system may further comprise meat processing means such as:
means for automatic reducing the power of the microwave emitting device after a pre-determined time period or after delivery of a pre-determined amount of energy, and/or
means for pulsing the microwave treatment and/or
at least one cooling device for cooling the atmosphere of the treatment chamber and/or for cooling the at least one meat piece in the treatment chamber and/or for cooling the at least one meat piece after decontamination of the surface, and/or
at least one sous vide bath or sous vide oven being located after said treatment chamber or after said cooling chamber, and/or
at least one marinating device being located before said treatment chamber, and/or
at least one packaging means for packaging meat pieces, said at least one packaging means being located before said treatment chamber, and/or
at least one mechanical tenderizer.

In the system the treatment chamber as described herein may correspond to a first treatment chamber and the system may further comprise a second treatment chamber which can be constructed as described herein in respect of the first chamber, and conveyor means for conveying meat pieces from the first treatment chamber to the second treatment chamber. The first and second treatment chamber may be identical in construction and equipment or they may be constructed due to the intended use of each chamber.

Conveyor means for conveying meat pieces from the first treatment chamber to the second treatment chamber may be an opening between the two chambers making it possible for a food/meat piece to be transferred from the first treatment chamber to the second treatment chamber e.g. by gravity. Thus a door capable of closing an opening may be a conveyor means between the first and second treatment chamber. Conveyor means e.g. as conveyor belts may also be located before the first treatment chamber, after the second treatment chamber and/or between the first and second treatment chamber. Conveyor means is preferably present in both the first and second treatment chamber. Preferably a conveyor means comprise a conveyor belt. Conveyor means in the first treatment chamber preferably comprises a rotating mechanism.

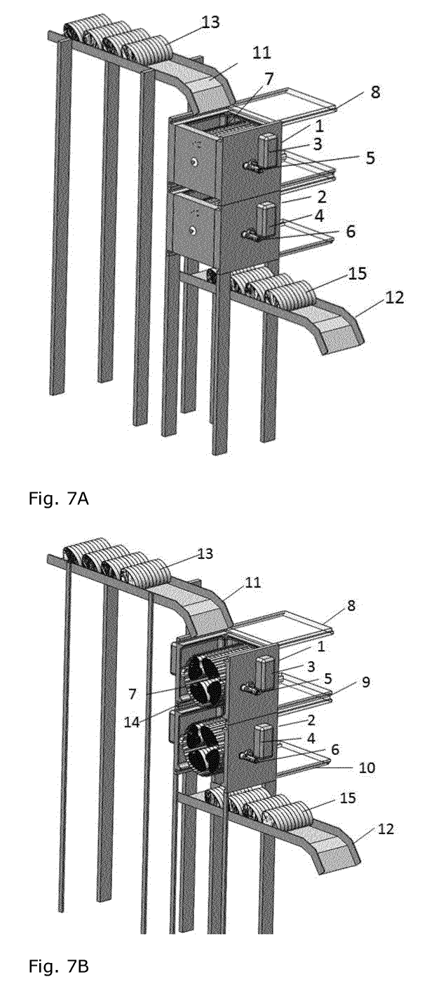

Below is described a treatment system for decontamination of food/meat surfaces and one way of using such a system. The system may be different and the system as described may be used with other treatment conditions. The system is illustrated in FIG. 7. Raw and/or processed such as marinated meat pieces come on a conveyor into a first microwave-processing chamber (=first treatment chamber) with at least one microwave emitting device e.g. a magnetron where the surface layer of the meat pieces is heated by microwaves up to at least 70° C., e.g. 90° C., such as about 100° C. The highest possible microwave power can be applied in this chamber in order to provide for a quick heat stroke (heat shock) effect on the food/meat surface. The chamber may be equipped with one or more built-in remote infrared temperature sensors.

As soon as the temperature at the food/meat surface reaches a pre-determined temperature e.g. 90° C., such as 95° C. or e.g. 100° C. the food/meat pieces can be directed into the second microwave-processing chamber (=second treatment chamber) where significantly lower microwave power and/or pulsed microwave treatment may be applied simply for maintaining the surface temperature at the level of 90° C., such as 95° C. or e.g. 100° C. in the course of the time necessary to achieve the desired reduction of microorganisms, which may correspond to treatment conditions capable of obtaining a reduction of C. botulinum by 6 logarithmic units.

Along with the microwave hardware, the second chamber may comprise one or more high-power pneumatic ultrasound generators and an exhaust ventilation. The pneumatic ultrasound generators maintain turbulent atmosphere in the chamber, thereby improving heat removal from the meat surface. The mechanism of augmentation of heat transfer by means of ultrasound irradiation is well-established: high-power ultrasound irradiation results in turbulization of boundary layer adjoining food/meat surfaces, thereby improving heat transfer through the turbulent ‘acoustic’ boundary layer.

After the described microwave decontamination combined with ultrasound-assisted heat removal, the food/meat products can be directed from the second chamber to a packaging area or e.g. into a sous-vide processing zone.

Within one or more of the treatment chambers the food/meat pieces may rotate during microwave treatment. In FIG. 7 each of the two treatment chambers are illustrated with four meat pieces and each meat piece is located within a basket on a carousel. Each of the carousels with four baskets may rotate along a first circular path such that the carousel revolves around a center. Each basket may individually rotate around a second circular path. Hereby the meat pieces rotate around two circular paths and a more even microwave treatment of the meat surface is obtained.

The system as described herein may further comprise meat processing means located before and/or after the food/meat pieces are subjected to the surface decontamination in a first and/or second treatment chamber. Such meat processing means may be at least one sous-vide bath located at least after the treatment chamber where surface decontamination occurs, at least one marinating device located before and/or after the treatment chamber and/or at least one mechanical tenderizer preferably located after the treatment chamber to reduce the risk of contaminating the central meat part with microorganism which might be present at the surface of non-decontaminated meat pieces.

The system may also comprise a packaging means for packaging food/meat pieces. A packaging means may be positioned before and/or after the treatment chamber where the food/meat piece is treated with microwaves.

Preferably a packaging means is positioned before the treatment chamber such that the food/meat piece is packed before being treated with microwaves. Packaging means are known in the art. Preferably the packaging means such as packaging with susceptors are capable of producing packagings that are air-tight such as vacuum packaging.

Preferred is also packaging means capable of packing food/meat pieces into material comprising susceptors such as vacuum packaging in material with susceptors.

A packaging means may be connected to a controlling means and automatically transfer information in respect of type of packaging used for a food/meat piece such that the controlling means can determine e.g. the treatment time, microwave frequency or microwave power for the individual food/meat piece to obtain surface decontamination of the food/meat piece.

The system as described herein preferably comprises material and design making it capable for the entire system to be approved for food production due to a hygienic design with an acceptable level according to the International Standard ISO 14159:2002(E).

An aspect of the invention relates to use of the system as described herein for decontamination at least one food/meat piece. Preferably the use of the system is for treating meat pieces to obtain surface decontaminated meat pieces with a non-processed interior.

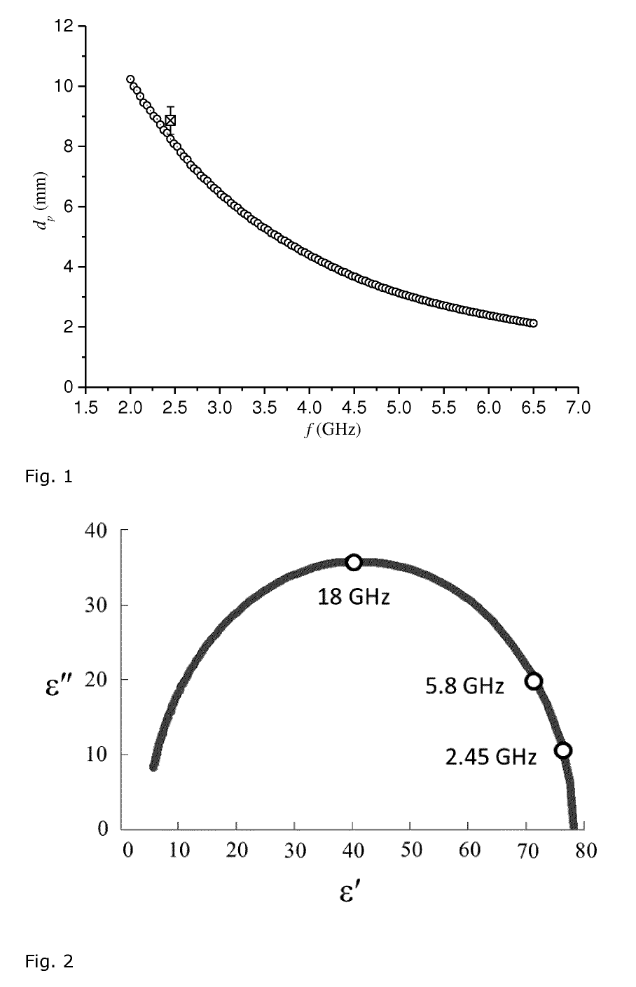

FIG. 1. Microwave penetration depth in beef as a function of the frequency of microwaves. The X-axis is the frequency (f) in GHz and the Y-axis is microwave power penetration depth (dₚ) in mm. Measurements of dielectric constants were used to calculate microwave power penetration depth. The dielectric permittivity ∈′(T) and the dielectric loss ∈′(T) were measured on beef (cattle roast beef) using E5071C Network Analyzer and 85070E Dielectric Probe Kit (Agilent Technologies). See also Example 1. The microwave power penetration depth was then derived from the dielectric constants. The penetration depth for 2.45 GHz indicated by a square is calculated using the data on dielectric constants for the raw beef published in: Risman, P. Microwave dielectric properties of foods and some other substances. In eds. Lorence, Matthew W. and Pescheck, Peter S. Development of packaging and products for use in microwave ovens. Woodhead Publishing Limited (ISBN 978-1-84569-420-3), p. 168.

FIG. 2. Cole-Cole equation curve which describes dielectric relaxation in water at 25° C. (Cole, K. S.; Cole, R. H. “Dispersion and Absorption in Dielectrics—I Alternating Current Characteristics”. J. Chem. Phys. 9 (1941) 341-352. DOI:10.1063/1.1750906; J. Suhm, M. Möller, H. Linn. New Development for Industrial Microwave Heating. International Scientific Colloquium Modelling for Electromagnetic Processing, Hannover, March 24-26, 2003).

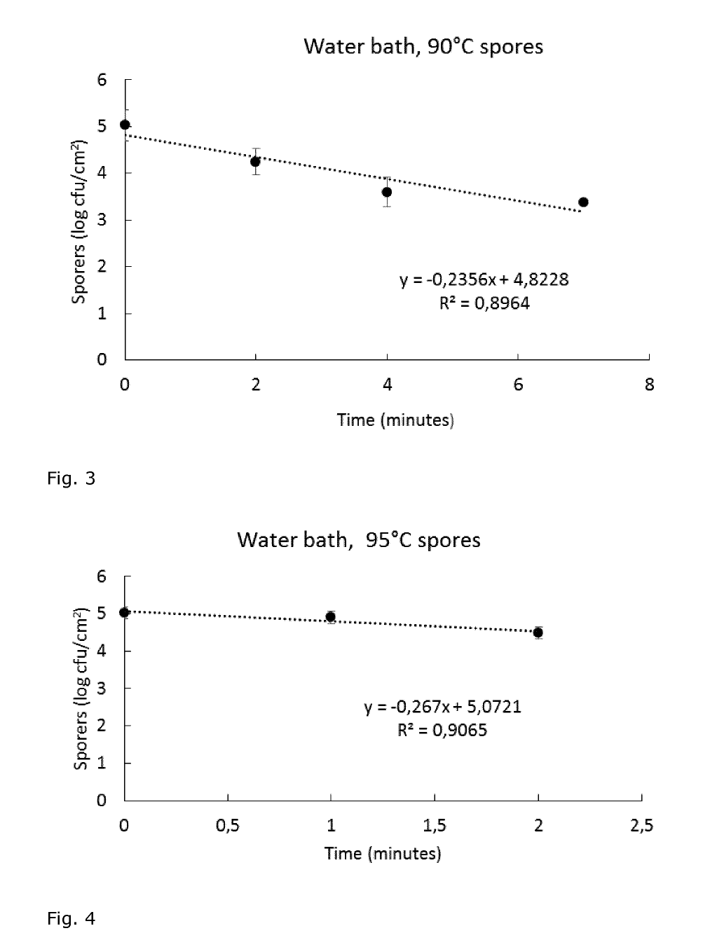

FIG. 3. Results from Example 2. Viable spores of C. botulinum after treatment of inoculated meat pieces in water bath at 90° C. for 2, 4 and 7 minutes. The graph shows log (log cfu/cm²) of spores as a function of time in minutes.

FIG. 4. Results from Example 2. Viable spores of C. botulinum after treatment of inoculated meat pieces in water bath at 95° C. for 0.5, 1 and 2 minutes. The graph shows log (log cfu/cm²) of spores as a function of time in minutes.

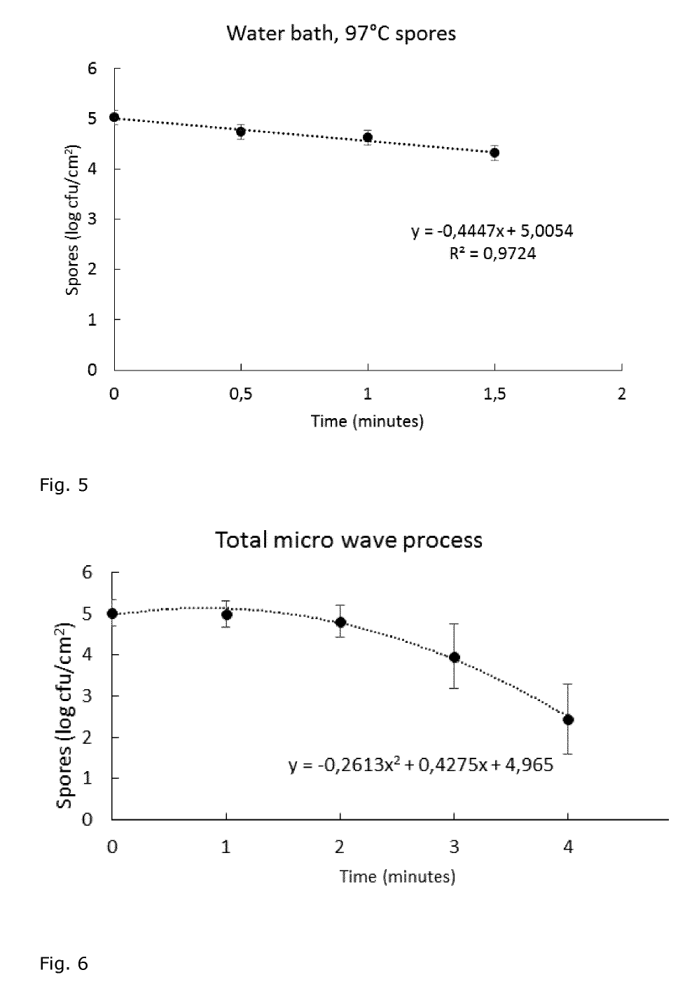

FIG. 5. Results from Example 2. Viable spores of C. botulinum after treatment of inoculated meat pieces in water bath at 97° C. for 0.5, 1 and 1.5 minutes. The graph shows log (log cfu/cm²) of spores as a function of time in minutes.

FIG. 6. Results from Example 2. Viable spores of C. botulinum after treatment of inoculated meat pieces by microwaves at 5.8 GHz for 1, 2, 3 and 4 minutes. The graph shows log (log cfu/cm²) of spores as a function of time in minutes.

FIG. 7. Example of a system for decontaminating at least one meat piece. The system is illustrated with two chambers (1, 2) located above one another and with conveyors (11, 12) to the first chamber (1) and from the second chamber (2). FIG. 7a illustrates the system when microwaves are emitted i.e. the chambers in which microwaves are emitted are closed although the closed inlet (8) of the first chamber (1) is not illustrated above the circulating meat pieces in the rotating mechanisms (7). The system as illustrated comprises a first chamber (1), a second chamber (2), microwave waveguides (3), microwave waveguides or pneumatic ultrasound generators (4), infrared pyrometer (5, 6), rotating mechanism in the chambers (7), first chamber inlet (8), first chamber outlet and second chamber inlet (9), second chamber outlet (10), conveyor to first chamber (11), conveyor from second chamber (12), meat pieces before decontamination (13), meat pieces inside first or second chamber (14), decontaminated meat pieces (15).

The system when in function can be described such that meat pieces (13) which may be packed or un-packed are directed towards the first chamber (1) by a conveyor (11). The meat pieces enters a rotating mechanism (7) in the first chamber (1) where the meat pieces are subjected to microwaves from at least one microwave emitting device directing the microwaves through at least one microwave waveguide (3) while the meat pieces (14) are pivoted along a first and/or second orbit or circular path by pivoting the entire rotating mechanism (7) and/or each of the holding means holding a meat piece (14). The rotating mechanism (7) here illustrated each with four meat pieces may be directed from the first chamber (1) to the second chamber (2) or the meat pieces (14) may be directed from the holding means (7) in the first chamber (1) to the holding means (7) in the second chamber (2). The decontaminated meat pieces (15) can be removed from the second chamber (2) by a conveyor (12). The decontaminated meat pieces (15) can be further processed e.g. cut into smaller pieces, minced, externally marinated, internally marinated e.g. with brine, and/or subjected to a sous vide treatment. Conveyor from the second treatment chamber (12) may also direct the surface decontaminated meat pieces (15) to a packing department.

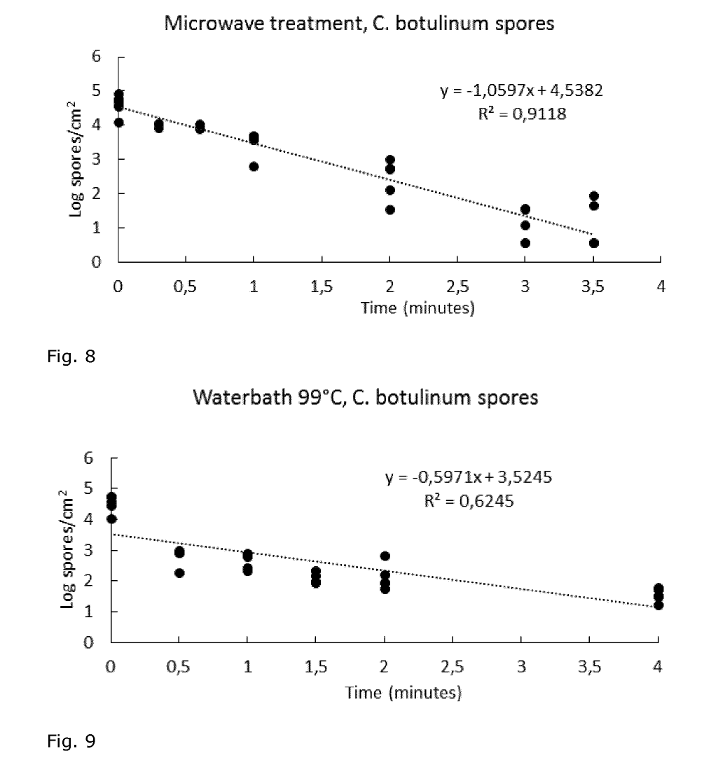

FIG. 8 illustrates results from Example 3. Number of C. botulinum spores/cm² after treatment of inoculated meat pieces in microwave oven (5.8 GHz) for 0-3.5 minutes. 0-1 minute=full power; 1-3.5 minutes=25% power.

FIG. 9 illustrates results from Example 3. Number of C. botulinum spores/cm² after treatment of inoculated meat pieces in water bath at 99° C. for 0-4 minutes.

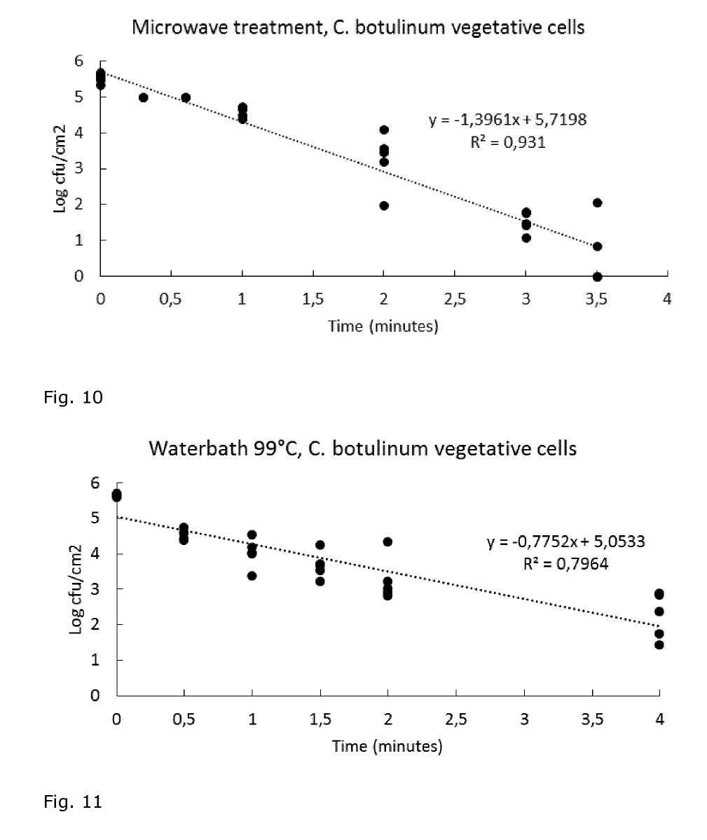

FIG. 10 illustrates results from Example 3. Number of C. botulinum (vegetative cells)/cm² after treatment of inoculated meat pieces in microwave oven (5.8 GHz) for 0-4 minutes. 0-1 minut=full power; 1-3.5 minutes=25% power.

FIG. 11 illustrates results from Example 3. Number of C. botulinum (vegetative cells)/cm² after treatment of inoculated meat pieces in water bath at 99° C. for 0-4 minutes.

FIG. 12 illustrates one possibility of rotation in two paths. An illustration of a system (16) for decontamination is seen with four meat pieces (14) located in a system such as the one illustrated in one of the chambers in FIG. 7B. The small dotted circles (17) illustrate one circular path for each meat piece (14) and the large dotted circle (18) illustrates one circular path for the entire system here illustrated with four meat pieces. The arrows indicate possible direction of rotation for each meat piece holder (not illustrated) and for the entire rotating mechanism (7 in FIG. 7B). At the same time as the meat rotate in the two circular paths the entire system may be directed through a treatment chamber of a system for surface decontamination such as through a horizontal or vertical treatment tunnel. Different number of meat pieces in a rotating mechanism and different rotation directions are also possible.

FIG. 13 illustrates a system (16) for decontaminating meat pieces or food items. The system is illustrated with two treatment chambers (1, 2) located after one another and with conveyors (11, 12) to the first chamber (1) and from the second chamber (2), respectively. The first chamber (1) is a thermal shock cavity and the second chamber (2) is a temperature maintenance cavity. Microwave radiation traps (19, 21) with at least one door (20), such as automatic doors, are located before the first treatment chamber (1) and after the second treatment chamber (2) to secure absorption of emitted microwaves within the system. A rotating mechanism (7) is located in the first chamber (1) which also has at least one microwave emitting device and waveguides (3). Preferably more microwave emitting devices and waveguides are present dependent on the size of the first chamber (1). Multiple microwave emitting devices and waveguides (3) are also connected to the second treatment chamber (2). Monitoring means and controlling means such as for controlling frequency and duration of emitted microwaves and temperature measurement are not shown, but may be a part of the system. Cooling devices may be located within the second chamber or after the second chamber.

When a system (16) as illustrated in FIG. 13 is in function food items or meat pieces (13) which may be packed or un-packed such as vacuum packed are conveyed be a conveyor (11) into a microwave radiation trap (19) through the doors (20) and further into the first treatment chamber (1) in the form of a thermal shock cavity where the food item or meat piece is located in a rotating mechanism (7), which may be capable of holding more than the four meat pieces as illustrated. The food items or meat pieces while rotating preferably along two circular paths by rotating the rotating mechanism (7) are treated by microwaves emitted into the first treatment chamber (1) from the microwave emitting devices and waveguides (3) to reach a pre-determined temperature at the meat surface. Surface temperature of food item or meat pieces can be monitored by temperature measuring devices (not illustrated) located in the first chamber (1) as well as in the second chamber (2). When the pre-determined temperature is reached at the meat surface the food item or meat piece in the first chamber (1) is conveyed into the second chamber (2) for maintaining the surface temperature. Food items or meat pieces may in the second chamber be conveyed one by one as illustrated or still be located in the rotating mechanism. In the second chamber (2) the pre-determined temperature at the surface of the food items or meat pieces is maintained for a pre-determined time by applying microwaves at a lower power than in the first treatment chamber (1) and/or for shorter times such as in pulses to maintain the desired temperature and obtain surface decontamination. The multiple microwave emitting devices in the second chamber (2) may be capable of being controlled individually making it possible to control the temperature of the surface of the conveyed food items or meat pieces. Other devices as described herein may be combined with the system (16).

FIG. 14 illustrates penetration of microwaves from every quarter: if penetration depths of microwaves are much less than the characteristic dimensions of a food pieces (left picture) then superposition (focusing) does not occur; the opposite case is shown in the right picture where the microwaves can superimpose in the core of the food piece resulting in formation of a hot spot.

### Examples

### 1. Microwave Penetration Depth in Red Meat

Beef meat (inside beef) was used to determine the penetration depth of microwaves with different frequencies in meat.

The dielectric permittivity ∈′(T) and the dielectric loss ∈″(T) were measured using an E5071C Network Analyzer and 85070E Dielectric Probe Kit (Agilent Technologies).

The microwave power penetration depth was then derived from the dielectric constants (see e.g. in Buffler, C. R. Microwave Cooking and Processing. Engineering Fundamentals for the Food Scientist, New York, AVI Book (1993)).

The results of measurements and calculations are shown in FIG. 1 and in the Table below, where ‘f’ is the frequency of the microwaves in GHz and ‘dₚ’ is the depth the microwave penetrates into the beef meat in mm.

| | | | | | | | | | |
|---|---|---|---|---|---|---|---|---|---|
| f, GHz | 5.8 | 5.9 | 6.0 | 6.1 | 6.2 | 6.3 | 6.4 | 6.5 | 7.0 |
| dₚ, mm | 2.50 | 2.44 | 2.37 | 2.33 | 2.28 | 2.22 | 2.17 | 2.12 | 1.98 |

2. Reduction of Viability of Spores of C. botulinum

A preliminary experiment with elimination of Clostridium botulinum spores has been performed. C. botulinum produces spores, which may not be present in food as the consequences to human health, when the bacteria develop in the food are massive. The spores of bacteria are much more difficult to eliminate than bacteria (vegetative cells). The experiment with microwave treatment of spores of C. botulinum is thus considered as an indication of whether the tested method is capable of reducing the number of spores and viable microorganisms of both C. botulinum and of other species.

Materials and method:
Clostridium botulinum strains DMRICC 3760, 3778, 3779 and 3765 from Danish Meat Research Institute, Denmark. The spores were transferred to TPGY (Tryptone Pepton Glucose Yeast) media for three days at 30° C. and under anaerobic conditions. 2 mL were transferred to CMM (Cooked Meat Medium) and were cultivated for 12 days at 30° C., anaerobic. The supernatant was centrifuged at 5,000 rpm for 15 minutes at 4° C. The pellet with the spores was re-suspended in 10 ml cold and sterile 0.85% saline, centrifuged at 5,000 rpm for 15 minutes at 4° C., and the pellet with the spores was again resuspended in 10 mL cold and sterile 0.85% saline.
Meat pieces: Silverside beef without membranes were cut into pieces of about 100 g and about 4.5*4.5*4.5 cm.
Inoculation of meat pieces with a mix of the four C. botulinum strains: The meat pieces were dried in a LAF bench for 15 minutes and 1 ml of a spore solution (10⁷ cfu/mL) was added to the surface, corresponding to about 10⁵ spores per cm² of the meat. The meat pieces were vacuum packed in airtight bags (PETP 12/PEP LDPE 75).
Microwave treatment: Four times three bags were treated with microwaves from a magnetron (M 5801 J, Muegge; 5800 MHz, 750 W) built onto a cavity (MH0750S-812BA) at full power for 1, 2, 3 or 4 minutes. The bags were afterwards immersed into ice-water.
Parallel treatment in water bath: Inoculated meat pieces as described were treated in water baths at 90° C. for 2, 4 or 7 minutes; at 95° C. for 0.5, 1 and 2 minutes or at 97° C. for 0.5, 1 and 1.5 minutes. 3 meat pieces for each treatment.
Analysis of treated meat pieces: Numbers of viable spores on the meat pieces were determined for each bag following growth on SFP-agar for 3 days at 30° C.

### Results:

The results of the experiment are shown in FIG. 3-6. The results for the water bath are shown in FIG. 3-5 for the temperatures 90° C., 95° C. and 97° C., respectively. The results for the microwave treatment are shown in FIG. 6. All figures show the spores (log cfu/cm² as a function of time (minutes)).

The results show a clear effect of all the treatments as a reduction of viable spores.

3. Inactivation of Clostridium botulinum

Clostridium botulinum strains, meat piece preparation and inoculation were performed as described in Example 2. In this experiment spores or vegetative cells were used for contaminating the meat pieces
For vacuum packed meat pieces the surface temperature were increase to 45° C. in a water bath at 55° C. for 5 minutes before treatment in the microwave oven or in a water bath at 99° C.
Microwave treatment: One bag at a time was treated with microwaves from a magnetron (M 5801 3, Muegge; 5800 MHz, 750 W) built onto a cavity (MH07505-812BA) at full power for 1 minutes and thereafter at 25% of full power for 0, 0.3, 0.6, 1, 2, 3 or 3.5 minutes. Each experiment at 0.3 and 0.6 minutes were repeated three times, and each experiment at 1, 2, 3 and 3.5 minutes were repeated five times. The bags were afterwards immersed into ice-water.
Water bath treatment at 99° C.: Inoculated meat pieces as described were treated in water baths at 99° C. for 0.5, 1, 2 and 4 minutes
Analysis of treated meat pieces: Spore analysis: Before analysis on SFP-agar the sample was heat treated 20 minutes at 75° C.; Vegetative cells: No heat treatment before analysis on SFP-agar. Numbers of spores and vegetative cells of C. botulinum were analysed on SFP-agar for 3 days at 30° C.

The results are shown in FIG. 8-11. The D-values for spores and vegetative cells of C. botulinum for each treatment was calculated from the regression lines.

The D-values for the microwave treatment and the heat treatment at 99° C. are shown in the table below together with D-values from microwave treatment at full effect and water bath treatment at 90, 95 and 97° C. from Example 2. A D-value of 1.5 minutes was calculated for treating C. botulinum spores in 100° C. water bath and thus a 6 log reduction can be obtained by 9 minutes of treatment.

| | | | | | | Time to |
|---|---|---|---|---|---|---|
| | | | | | | 6 log |
| | | | | D- | | reduc- |
| Exam- | | | Temper- | value | R²- | tion |
| ple | | | ature, | (min- | regres- | (min- |
| No. | Treatment | Cells | deg. C. | utes) | sion | utes) |
| 2 | Water bath | Spores, all | 90 | 3.99 | 0.8157 | 23.94 |
| 2 | Water bath | Spores, all | 95 | 3.64 | 0.33 | 21.84 |
| 2 | Water bath | Spores, all | 97 | 2.22 | 0.588 | 13.32 |
| 3 | Water bath | Spores, all | 99 | 1.67 | 0.6245 | 10.02 |
| 2 | Microwaves | Spores, all | — | 0.68 | 0.8644 | 4.08 |
| 3 | Microwaves | Spores | — | 0.94 | 0.9118 | 5.64 |

The results show that a 6 log reduction of the applied strains requires a heat treatment at 99° C. for 10.02 minutes. A 6 log reduction of C. botulinum is achieved after 5.64 minutes in a microwave oven (5.8 GHz) with full power for 1 minute followed by reduction of the power to 25%.

### Calculation of the Energy Input Required for 6 Log Reduction

This calculation is carried out for the processing sequence used in experiment 3. In the experiment, 4.5×4.5×4.5 cm pieces of unprocessed lean beef of cubic shape with rounded corners (total surface area of S=121 cm²) and vacuum-packed in polymer plastic bags were subjected to a three-stage thermal treatment from start temperature of 20° C.:
1. Holding in 55° C. water bath for t_{b}=5 minutes until the surface temperature reached 45° C.
2. Heating by 5.8 GHz microwaves for 1 minute, the available microwave power in the cavity was measured to be P_{M}=182 W.
3. Heating by 5.8 GHz microwaves for 1, 2, and 2.5 minutes at 25% of the available power, i.e. 0.25·P_{M}=45.5 W

The energy input in the second and the third process by microwaving can be straightforwardly estimated as

P_{M} 1 minute+0.25 P_{M} 1 minute=13.65 kJ (for 1 minute microwave processing at 25% power setting),
P_{M} 1 minute+0.25 P_{M} 2 minutes=16.38 kJ (for 2 minutes microwave processing at 25% power setting),
P_{M} 1 minute+0.25 P_{M} 2.5 minutes=17.75 kJ (for 2.5 minutes microwave processing at 25% power setting).

The first process assumes convective heat transfer and the estimation of its energy input is less straightforward since both heat transfer at the “bath water-packaging film-water column-meat surface” interface as well as the thermal conductivity (diffusivity) of the meat must be taken into account. In order to make this estimation in as simple manner as possible, the Einstein's relation for the calculation of the heat diffusion length was applied L=\sqrt{χt_{b}}.

The diffusion length L can be interpreted as being a minimal depth where the temperature of the meat after the time of t_{b}=5 minutes of the residence in the hot water bath has remained unchanged, i.e. is still 20° C. This length can also be called the heat-affected zone. Then, χ is the thermal diffusivity of the meat. The following values of physical parameters of the meat necessary for the calculation are assumed:

mass density: ρ=1.15 g/cm³,
specific heat capacity: Cₚ=3700 J/(kg·K),
thermal conductivity: κ=0.45 W/(m·K),
thermal diffusivity: χ=κ/(ρCₚ)=1.058×10⁻⁷ m²/s.

This calculation results in the heat diffusion length of L=5.63 mm. Using the data for the surface temperature after preheating in the water bath (+45° C.) and assuming the initial temperature of the meat of e.g. 20° C., it is possible to calculate the heat transfer rate Q through the meat surface by applying the Fourier's law in a finite-difference form

$$\vert Q \vert = κ \cdot \frac{Δ T}{L} .$$

Here, ΔT=25° C. is the difference of the meat surface temperature after the water bath and the initial meat surface temperature. This simplified equation is applicable here since the heat diffusion length (heat-affected zone) is almost 10 times smaller than the characteristic dimensions of the meat pieces. Eventually, calculation gives the value of the heat transfer rate Q≈2000 W/m², and the energy input can be calculated as Q·S·t_{b}=7.29 kJ.

Thus the maximum energy input (assuming 2.5 minutes of microwave processing at 25% of power setting) of all three stages is 17.75 kJ+7.29 kJ=25.04 kJ.

Conclusion: The above-described three-stage decontamination process requires transferring of approximately 25 kJ of energy through the 121 cm² meat surface to achieve 3.5 log reduction of spores of C. botulinum. To achieve a 6 log reduction of spores of C. botulinum approximately 2 minutes longer microwave process time at 0.25·P_{M} is required, corresponding to the transfer of about 5.5 kJ more energy to the surface of the meat piece

Vacuum Packaging Improves Decontamination Results with 5.8 GHz Microwaves as Compared with Water Bath Decontamination

There is a liquid column of high water content between the packaging film and the meat surface of packed meat pieces. If the entire decontamination process takes place in a hot water bath, this liquid together with the packaging film creates extra heat resistance between the hot water and the meat surface where spores are precipitated. In fact, this heat resistance is very significant, as it can be concluded from the fact that the surface temperature of the meat has become 45° C. after the 5 minutes residence in the 55° C. water bath. Therefore, the time necessary for a 6 log decontamination in 99° C. water bath needs to be longer than if the temperature above 90° C. would be instantaneously established at the meat surface.

In case of surface decontamination using 5.8-GHz microwaves, the process can be described as follows:
1. At the initial stage, the microwave energy is preemptively absorbed in the liquid column between the packaging material and the meat surface. Maximum 30-40% of the available microwave power reaches the meat surface since the power penetration depth of 5.8 GHz microwaves in the water is only ˜3.3 mm. This stage ends when the liquid column boils, and the temperature at the surface of the meat reaches 100° C. The boiling process results in steam formation and inflation of the packaging plastic bag. The increased headspace of the packaging is therefore filled with the water vapor. This moment is essential for improvement of the decontamination results since the steam condensation with the release of enormous amount of heat (latent heat of evaporation) happens right at the meat surface. Indeed, the surface is being continuously cooled by the heat outflow from the surface to the core of the meat due to the thermal conductivity. This cooling promotes the steam condensation on the meat surface.
2. When the liquid column evaporates, the meat surface gets open for the excess of the microwave radiation since microwaves do not experience that essential energy loss as they do in the water. Indeed, the power penetration depth of 5.8 GHz microwaves in water vapor is in the range of a few centimeters, depending on the steam pressure and temperature, while it is just a few millimeters in the water. Thus, the amount of microwave energy transferred directly to the surface of the meat is at least one order of magnitude larger than this is before the boiling occurs.

Eventually, the above-described processes promote faster decontamination of the meat surface with the use of microwaves than it is in a hot water bath without any microwave treatment, even though the temperature of the meat surface is approximately the same in both microwave and water bath processing.

What is claimed is:

1-15. (canceled)

16. A method for decontaminating the surface of at least one meat piece with a non-processed interior, said method comprising the steps of:
microwave treating at least one meat piece with a non-processed interior with microwaves in the range of 0.5-4 GHz or in the range of 4-18 GHz, wherein said microwave treating is performed on said at least one meat piece, the at least one meat piece packed in a packaging material comprising an active or passive material;
microwave treating the at least one meat piece for a time period such that the meat surface becomes decontaminated and the interior of the meat piece is not heated substantially; and
obtaining at least one surface decontaminated meat piece with a non-processed interior.

17. The method according to claim 16, wherein the packaging material comprises a susceptor material capable of interacting with microwaves by becoming heated.

18. The method according to claim 16, wherein said microwave treatment is performed for a duration of time such that water boils at the meat surface or between the meat surface and the packaging material, or both.

19. The method according to claim 16, wherein the packaging material is sealed by vacuum sealing.

20. The method according to claim 16, wherein the packaging material comprises at least one valve or semi-permeable membrane allowing steam to diffuse out of the packaging material, or both.

21. The method according to claim 16, further comprising cooling the at least one meat piece prior to the microwave treating, during the microwave treating, or after the meat piece with a non-processed interior is decontaminated, or any combination thereof.

22. The method according to claim 16, wherein microwave treating the at least one meat piece comprises simultaneously rotating the at least one meat piece along two circular paths.

23. The method according to claim 16, wherein microwave treating the at least one meat piece comprises applying energy to the surface of the at least one meat piece of 100-400 J per cm².

24. The method according to claim 16, wherein the power of the microwave treatment initially is at a maximum level, the method further comprising:
reducing the power of the microwave treatment to a level to maintain the water or produced steam at a pre-determined temperature such that substantially no more steam is produced inside the packaging material when the water at the meat piece surface or the water between the meat piece surface and the packaging material boils.

25. The method according to claim 16, further comprising a treatment step comprising:
subjecting said at least one surface decontaminated meat piece to a Sous Vide process; or
marinating said at least one meat piece before or after decontaminating the surface of the meat piece by microwaves.

26. A system for decontaminating at least one meat piece, said system comprising at least one treatment chamber comprising:
at least one microwave emitting device capable of emitting microwaves in at least part of the range of 0.5-18 GHz; and
means for simultaneously rotating the at least one meat piece along at least two circular paths.

27. The system according to claim 26, wherein said at least one treatment chamber comprises a tunnel or at least two treatment chambers located next to each other, said system comprising:
at least two microwave emitting devices capable of emitting microwaves in at least part of the range of 0.5-18 GHz, said at least two microwave emitting devices being located within the system such that at least one microwave emitting devices is located in a first section located close to an entrance of the system where a high power treatment is to be performed and at least one microwave emitting devices is located in a second section of the system where a lower power treatment is to be performed;
means for adjusting the power of the microwave emitting device such that the power in the second section is 10-90% lower than in the first section;
a conveyor system for transporting meat pieces through the treatment chamber; and
means for rotating the at least one meat piece along at least two circular paths.

28. The system according to claim 26, wherein said at least one microwave emitting device capable of emitting microwaves in at least part of the range of 0.5-18 GHz comprises at least two microwave emitting devices each capable of emitting microwaves in all or part of: the range of 2-4 GHz, the range of 4-8 GHz, the range of 8-12 GHz, or the range of 12-18 GHz, or any combination thereof.

29. The system according to claim 26 further comprising:
means for automatically reducing the power of the microwave emitting device after a pre-determined time period or after delivery of a pre-determined amount of energy; or
at least one cooling device for cooling the atmosphere of the treatment chamber, the at least one meat piece in the treatment chamber, or for cooling the at least one meat piece after decontamination of the surface, or any combination thereof; or
at least one sous-vide bath being located after said treatment chamber or after said cooling chamber; or
at least one marinating device being located before said treatment chamber; or
at least one packaging means for packaging meat pieces, said at least one packaging means being located before said treatment chamber; or
at least one mechanical tenderizer;
or any combination thereof.

30. The system according to claim 26, wherein said at least one meat piece has a non-processed interior before and after the microwave treatment.
